(19) United States
(12) Patent Application Publication
(10) Pub. No.: US 2025/0063618 A1
(43) Pub. Date: Feb. 20, 2025

(54) ML RECONFIGURATION AND TID-TO-LINK MAPPING PROCEDURES

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US)

(21) Appl. No.: 18/791,190

(22) Filed: Jul. 31, 2024

Related U.S. Application Data
(60) Provisional application No. 63/532,563, filed on Aug. 14, 2023.

(51) Int. Cl. H04W 76/15; H04W 88/10

(52) U.S. Cl. CPC H04W 76/15; H04W 88/10

(57) ABSTRACT

Methods and apparatuses for reconfiguration of setup links between multi-link devices (MLDs). An access point (AP) MLD comprises APs and a processor. The APs each comprise a transceiver configured to transmit on a link setup with a corresponding STA of a non-AP MLD. The APs are affiliated with the AP MLD for ML operation on the setup links. The processor is configured to generate a reconfiguration ML element that indicates affiliated APs that are to be removed from affiliation with the AP MLD. The transceivers are configured to transmit the reconfiguration ML element to the corresponding STAs of the non-AP MLD. The processor is configured to determine whether any of the affiliated APs that are to be removed remain affiliated after transmitting the reconfiguration ML element, and to update the element to indicate the remaining affiliated APs that are to be removed. The transceivers of remaining affiliated APs are configured to transmit the updated reconfiguration ML element to the corresponding STAs of the non-AP MLD.

### CROSS-REFERENCE TO RELATED APPLICATION AND CLAIM OF PRIORITY

This application claims priority under 35 U.S.C. § 119(e) to U.S. Provisional Patent Application No. 63/532,563 filed on Aug. 14, 2023, which is hereby incorporated by reference in its entirety.

### TECHNICAL FIELD

This disclosure relates generally to power management in wireless communications systems that include multi-link devices. Embodiments of this disclosure relate to methods and apparatuses that facilitate reconfiguration of setup links between multi-link devices in a wireless local area network communications system.

### BACKGROUND

Wireless local area network (WLAN) technology allows devices to access the internet in the 2.4 gigahertz (GHz), 5 GHz, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA). With bandwidth aggregation across multiple channels/bands, MLO offers significant gain in throughput and latency performance compared to single link operation in the previous generation (802.11ax).

The non-AP MLDs in 802.11be can have different capabilities in terms of multi-link operation. The current specification defines two special kinds of multi-link operations, namely, Enhanced Multi-Link Single Radio (EMLSR) operation and Enhanced Multi-Link Multi-Radio (EMLMR) operation.

Many 802.11be non-AP MLDs may only have a single radio. EMLSR enables a multi-link operation with a single radio. With EMLSR operation, such a non-AP MLD can achieve throughput enhancement with reduced latency-a performance close to concurrent dual radio non-AP MLDs.

EMLMR operation is another mode of operation newly defined in the IEEE 802.11be specification. With the EMLMR mode of operation, it is possible for an MLD with multiple radios to move transmit (TX)/receive (RX) chains from one link (e.g., a first link) to another link (e.g., a second link) of the same MLD, essentially increasing the spatial stream capability of the second link.

### SUMMARY

Embodiments of the present disclosure provide methods and apparatuses that facilitate reconfiguration of setup links between MLDs in a WLAN.

In one embodiment, an AP MLD is provided, comprising APs and a processor operably coupled to the APs. The APs each comprise a transceiver configured to transmit on a link setup with a corresponding STA of a non-AP MLD, wherein the APs are affiliated with the AP MLD for ML operation on the setup links. The processor is configured to generate a reconfiguration ML element that indicates one or more of the affiliated APs that are to be removed from affiliation with the AP MLD for the ML operation. The transceivers are further configured to transmit the reconfiguration ML element to the corresponding STAs of the non-AP MLD. The processor is further configured to determine whether any of the affiliated APs that are to be removed remain affiliated after transmitting the reconfiguration ML element, and to update the reconfiguration ML element to indicate the remaining affiliated APs that are to be removed. The transceivers of remaining affiliated APs are further configured to transmit the updated reconfiguration ML element to the corresponding STAs of the non-AP MLD.

In another embodiment, a method of wireless communication performed by an AP MLD that comprises APs is provided, wherein the APs each comprise a transceiver configured to transmit on a link setup with a corresponding STA of a non-AP MLD, wherein the APs are affiliated with the AP MLD for ML operation on the setup links. The method includes the steps of: generating, by a processor of the AP MLD, a reconfiguration ML element that indicates one or more of the affiliated APs that are to be removed from affiliation with the AP MLD for the ML operation, and transmitting, by the transceivers, the reconfiguration ML element to the corresponding STAs of the non-AP MLD. The method further includes the steps of: after transmitting the reconfiguration ML element, determining, by the processor, whether any of the affiliated APs that are to be removed remain affiliated, and updating, by the processor, the reconfiguration ML element to indicate the remaining affiliated APs that are to be removed. The method further includes the step of transmitting, by the transceivers of remaining affiliated APs, the updated reconfiguration ML element to the corresponding STAs of the non-AP MLD.

In another embodiment, a non-AP MLD is provided, comprising STAs and a processor operably coupled to the STAs. The STAs each comprise a transceiver configured to transmit on a link setup with a corresponding AP of an AP MLD, wherein the APs are affiliated with the AP MLD for ML operation on the setup links, and to receive a reconfiguration ML element from the corresponding AP of the AP MLD. The processor is configured to determine that the reconfiguration ML element indicates one or more of the affiliated APs that are to be removed from affiliation with the AP MLD for the ML operation. The transceivers are further configured to, after receiving the reconfiguration ML element, receive an updated reconfiguration ML element from corresponding remaining affiliated APs of the AP MLD. The processor is further configured to determine that the updated reconfiguration ML element indicates remaining affiliated APs that are to be removed.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example process of multi-link setup according to embodiments of the present disclosure;

FIG. 4 illustrates an example operation for continued inclusion of a Reconfiguration Multi-Link element in Beacon and Probe Response frames according to embodiments of the present disclosure;

FIG. 5 illustrates an example operation for EMLSR link removal before multi-link reconfiguration according to embodiments of the present disclosure;

FIG. 6 illustrates an example operation for EMLMR link removal before multi-link reconfiguration according to embodiments of the present disclosure; and

FIG. 7 illustrates an example process for reconfiguration of setup links between MLDs according to various embodiments of the present disclosure.

### DETAILED DESCRIPTION

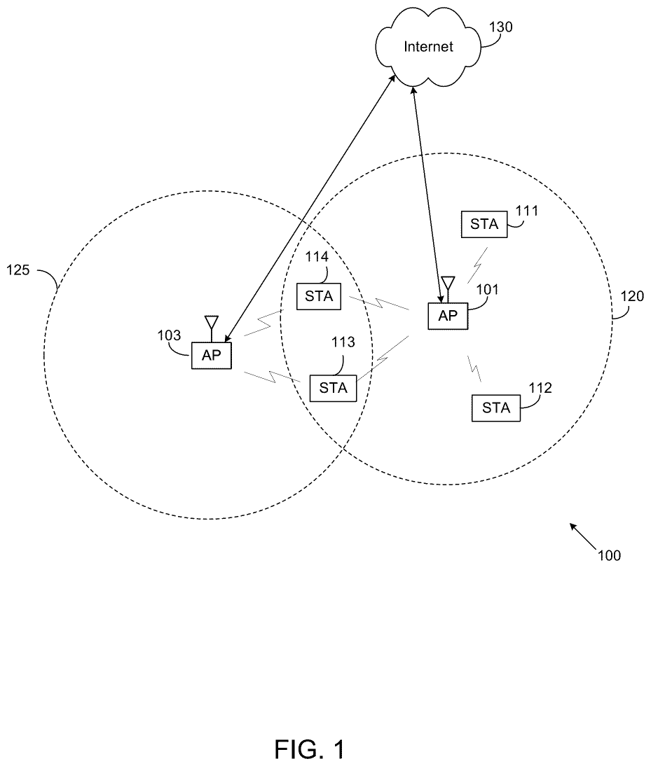

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that an AP MLD can use a multi-link (ML) reconfiguration procedure to add or remove one or more links, or a non-AP MLD can use the ML reconfiguration procedure to request to add or remove one or more links. Embodiments of the present disclosure additionally recognize that using an advertised traffic identifier (TID)-to-Link mapping (TTLM), an AP can disable a link for all non-AP MLDs associated with the AP MLD.

However, the ML reconfiguration procedure and TID-to-Link mapping (TTLM) procedure are not fully defined. Accordingly, embodiments of the present disclosure provide systems and methods for facilitating reconfiguration of setup links between MLDs. For example, embodiments of the present disclosure provide procedures for inclusion of an MLD media access control (MAC) address in an ML Reconfiguration element, continuation of inclusion of the Reconfiguration ML element in Beacon and Probe Response frames after removal of an affiliated AP, link removal with EMLSR or EMLMR operation, and disassociation of a non-AP MLD from an AP MLD after removal (or disablement) of all setup links between the non-AP MLD and the AP MLD.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

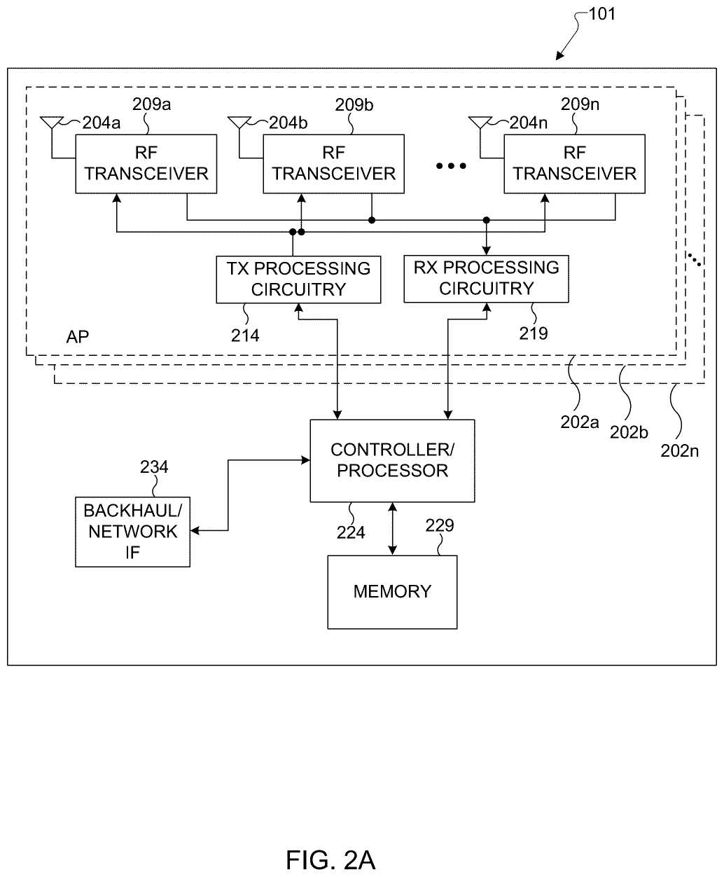

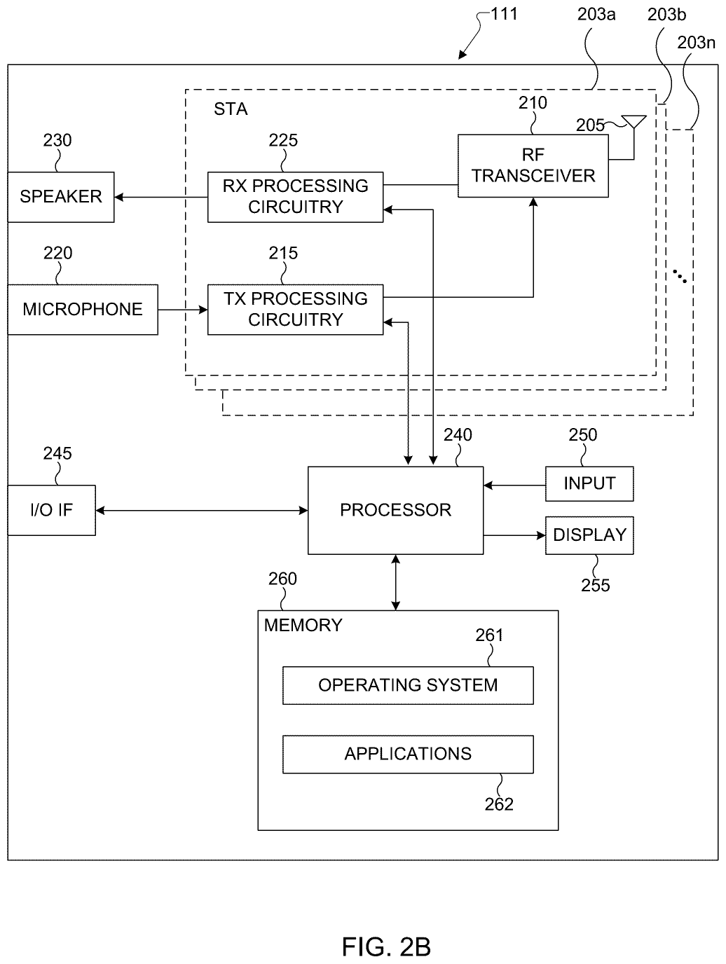

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate reconfiguration of setup links between MLDs in a WLAN. In some embodiments, the controller/processor 240 includes at least one microprocessor or microcontroller.

The controller/processor 240 is also capable of executing other processes and programs resident in the memory 260, such as operations for facilitating reconfiguration of setup links between MLDs in a WLAN. The controller/processor 240 can move data into or out of the memory 260 as required by an executing process. In some embodiments, the controller/processor 240 is configured to execute a plurality of applications 262, such as applications for facilitating reconfiguration of setup links between MLDs in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

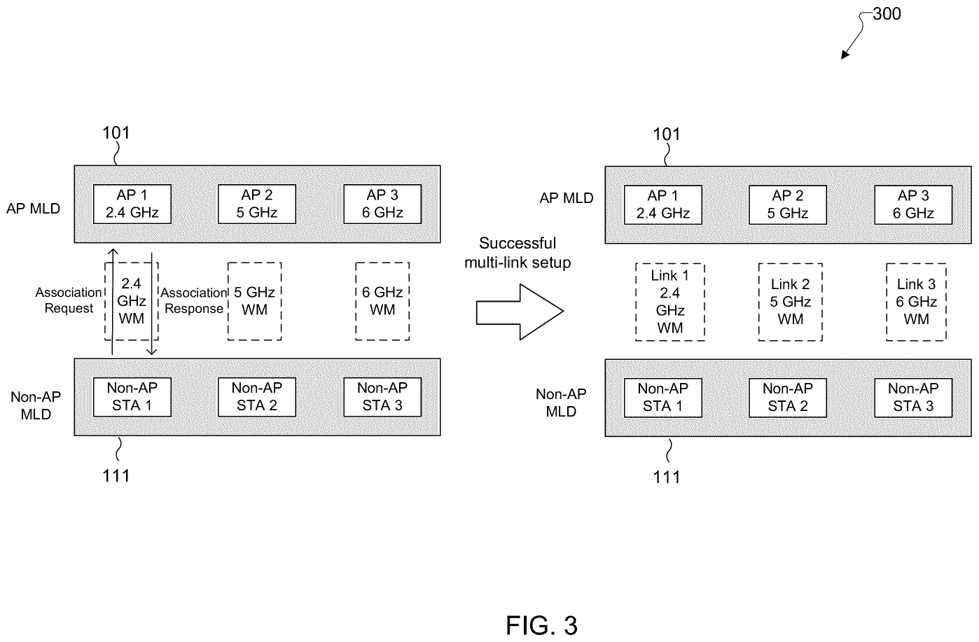

FIG. 3 illustrates an example process 300 of multi-link setup according to embodiments of the present disclosure. In this example, the AP MLD may be an AP MLD 101, and the non-AP MLD may be a non-AP MLD 111. Although the AP MLD 101 is illustrated with three affiliated APs (AP1, AP2, and AP3) and the non-AP MLD 111 is illustrated with three affiliated non-AP STAs (non-AP STA1, non-AP STA2, and non-AP STA3), it is understood that this process could be applied with suitable MLDs having any number of affiliated APs or STAs. For ease of explanation, it is understood that references to an AP MLD and a non-AP MLD in further embodiments below refer to the AP MLD 101 and non-AP MLD 111, respectively.

In the example of FIG. 3, an exchange of Association Request frame and Association Response frame takes place over the 2.4 GHz link between the AP MLD and the non-AP MLD, where the setup is for establishing three links between the AP MLD and the non-AP MLD: one link on the 2.4 GHz band, a second link on the 5 GHz band, and a third link on the 6 GHz band. After the successful ML setup, the three links are established between the AP MLD and the non-AP MLD-Link 1 between AP1 and non-AP STA1, Link 2 between AP2 and non-AP STA2, and Link 3 between AP3 and non-AP STA3.

After the successful ML setup the AP MLD can use the ML reconfiguration procedure to add or remove links (or to add or remove affiliated APs) for the ML operation. Likewise, the non-AP MLD can use the ML reconfiguration procedure to request that the AP MLD add or remove links (or to add or remove affiliated APs) for the ML operation. Additionally, an AP can use an advertised TID-to-Link Mapping (TTLM) procedure to disable a link for all non-AP MLDs associated with the AP MLD. Embodiments of the present disclosure provide solutions to several issues with regard to the ML reconfiguration and TTLM procedures.

According to one embodiment, for a case in which an AP MLD generates a Reconfiguration Multi-Link element to indicate that it is removing an affiliated AP of the AP MLD from affiliation with the AP MLD for ML operations, the Reconfiguration Multi-Link element is included in Beacon and Probe Response frames and an MLD MAC Address Present subfield in the Reconfiguration Multi-Link element can be set to 1. If the MLD MAC Address Present subfield is set to 1, then the MLD MAC Address in the Reconfiguration Multi-Link element can be the same as the MLD MAC Address of the AP MLD (or the AP MLD ID subfield) for which the AP MLD removal information is provided.

According to one embodiment, when an AP MLD intends to remove a first affiliated AP, then in the Reconfiguration Multi-Link element included in Beacon and Probe Response frames transmitted by any AP affiliated with the AP MLD, the MLD MAC Address Present subfield can be set to 1 if after removal of the first AP only one AP remains that is affiliated with the AP MLD. If instead after removal of the first AP more than one APs remain affiliated with the AP MLD, then the MLD MAC Address Present subfield can be set to 0 and the AP MLD for which the AP removal information is provided in the Reconfiguration Multi-Link element is identified by the MLD MAC Address subfield of the Basic Multi-Link element corresponding to the same AP MLD that is carried in the same Management frame.

According to one embodiment, after removal of an AP affiliated with an AP MLD through announcement in Beacon and Probe Response frames using the Reconfiguration Multi-Link element, if there are other affiliated APs that are still pending removal, then the AP MLD continues to include the Reconfiguration Multi-Link element in the Beacon and Probe Response frames that it transmits through any affiliated AP, and a Per-STA Profile sub-element corresponding to each of the affiliated APs that are pending removal can continue to be included in the Reconfiguration Multi-Link element. For any APs that have been removed from affiliation, the corresponding Per-STA Profile sub-element may be removed from the Reconfiguration Multi-Link element before subsequent transmission. The AP MLD may stop including the Reconfiguration Multi-Link element in the Beacon and Probe Response frames when there are no Per-STA Profile sub-elements remaining (i.e., when all of the affiliated APs that were pending removal have been removed).

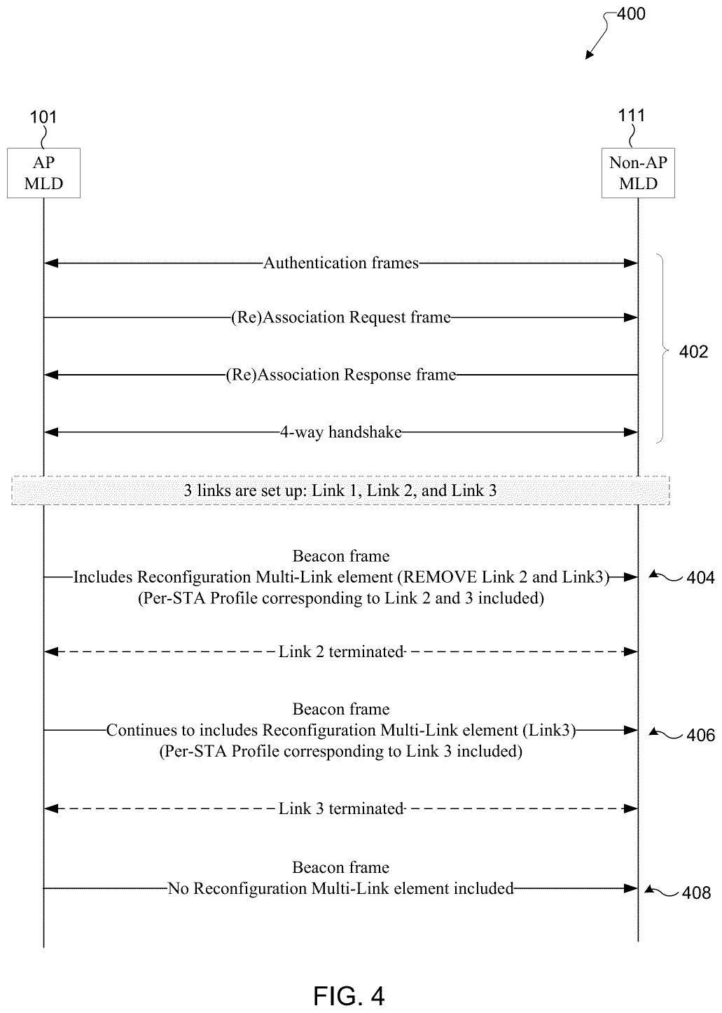

FIG. 4 illustrates an example operation 400 for continued inclusion of a Reconfiguration Multi-Link element in Beacon and Probe Response frames according to embodiments of the present disclosure. In this example, the AP MLD may be an AP MLD 101, and the non-AP MLD may be a non-AP MLD 111.

In the example of FIG. 4, the messages 402 comprise the ML setup procedure between the AP MLD and the non-AP MLD. The ML setup may be performed over any link established between an AP affiliated with the AP MLD and a STA affiliated with the non-AP MLD. In this example, after successful ML setup, three links are set up for ML operation (Link 1, Link 2, and Link 3).

The AP MLD then transmits a Beacon frame 404 that includes a Reconfiguration Multi-Link element indicating that Link 2 and Link 3 are to be removed (e.g., the affiliated APs corresponding to Link 2 and Link 3 are to be disabled or removed from affiliation with the AP MLD for ML operation). Per-STA Profile sub-elements corresponding to Link 2 and Link 3 are included in the Reconfiguration Multi-Link element.

Link 2 is then terminated, but Link 3 is still pending removal when the AP MLD transmits Beacon frame 406. Accordingly, Beacon frame 406 continues to include the Reconfiguration Multi-Link element. The Reconfiguration Multi-Link element now indicates that Link 3 is to be removed, and includes the Per-STA Profile sub-element corresponding to Link 3 (e.g., the Per-STA Profile sub-element corresponding to Link 2 may be removed from the Reconfiguration Multi-Link element).

Link 3 is then terminated, after which there are no links still pending removal. Accordingly, Beacon frame 408 does not include the Reconfiguration Multi-Link element. For example, after removal of the Per-STA Profile sub-element corresponding to Link 3 from the Reconfiguration Multi-Link element, the AP MLD may determine that there are no Per-STA Profile sub-elements remaining in the Reconfiguration Multi-Link element and therefore determine not to continue including the Reconfiguration Multi-Link element in the Beacon frames.

According to one embodiment, when a non-AP MLD is operating in EMLSR mode with an associated AP MLD and a first link between the AP MLD and the non-AP MLD is included in the EMLSR links, if the AP MLD intends to remove the first link using the multi-link reconfiguration procedure, then the first link will be removed from the EMLSR links before the first link is removed from MLO using the Multi-Link Reconfiguration procedure.

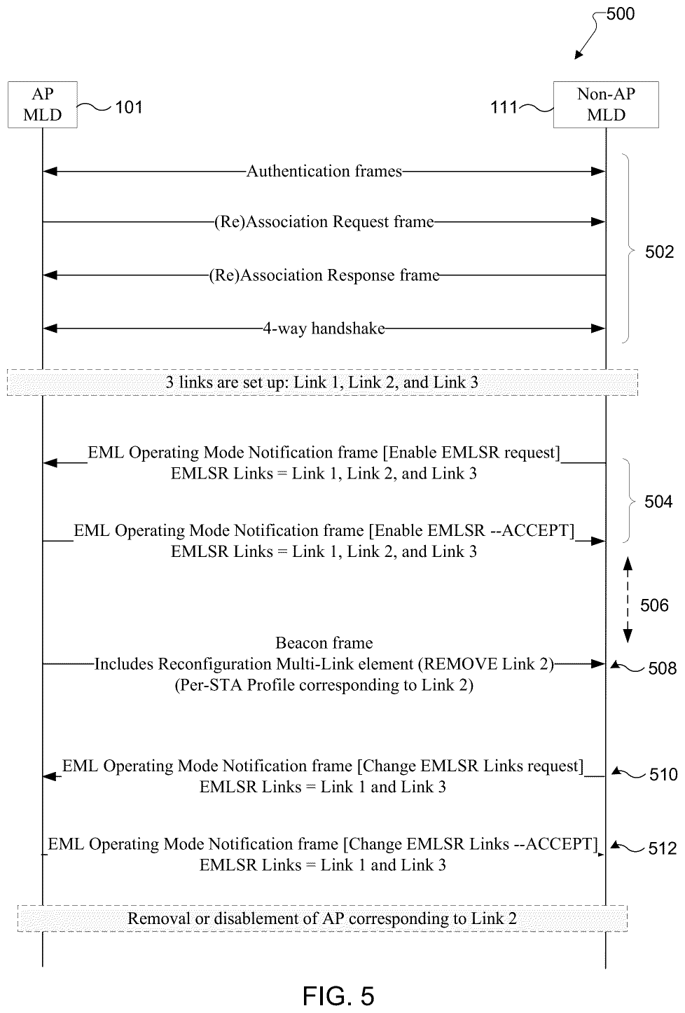

FIG. 5 illustrates an example operation 500 for EMLSR link removal before multi-link reconfiguration according to embodiments of the present disclosure. In this example, the AP MLD may be an AP MLD 101, and the non-AP MLD may be a non-AP MLD 111.

In the example of FIG. 5, the messages 502 comprise the ML setup procedure between the AP MLD and the non-AP MLD. The ML setup may be performed over any link established between an AP affiliated with the AP MLD and a STA affiliated with the non-AP MLD. In this example, after successful ML setup, three links are set up for ML operation (Link 1, Link 2, and Link 3).

The messages 504 comprise the EMLSR negotiation procedure between the AP MLD and the non-AP MLD. In this example, EMLSR is enabled on Link 1, Link 2, and Link 3 (that is, Link 1, Link 2, and Link 3 are included in the EMLSR links). EMLSR operation occurs during the time period 506 with Link 1, Link 2, and Link 3 as the EMLSR links.

The AP MLD then transmits a Beacon frame 508 that includes a Reconfiguration Multi-Link element indicating that Link 2 is to be removed (e.g., the affiliated AP corresponding to Link 2 is to be disabled or removed from affiliation with the AP MLD for ML operation). A Per-STA Profile sub-element corresponding to Link 2 is included in the Reconfiguration Multi-Link element.

In response to the Beacon frame 508, the non-AP MLD transmits a request 510 to change the EMLSR link list to Link 1 and Link 3 (i.e., to remove Link 2 from the EMLSR links). The AP MLD response with an accept message 512. Afterwards, EMLSR operation occurs with Link 1 and Link 3 as the EMLSR links, and Link 2 is removed (i.e., the affiliated AP corresponding to Link 2 is removed or disabled).

According to one embodiment, when a non-AP MLD is operating in EMLMR mode with an associated AP MLD and a first link between the AP MLD and the non-AP MLD is included in the EMLMR links, if the AP MLD intends to remove the first link using the multi-link reconfiguration procedure, then the first link will be removed from the EMLMR links before the first link is removed from MLO using the Multi-Link Reconfiguration procedure.

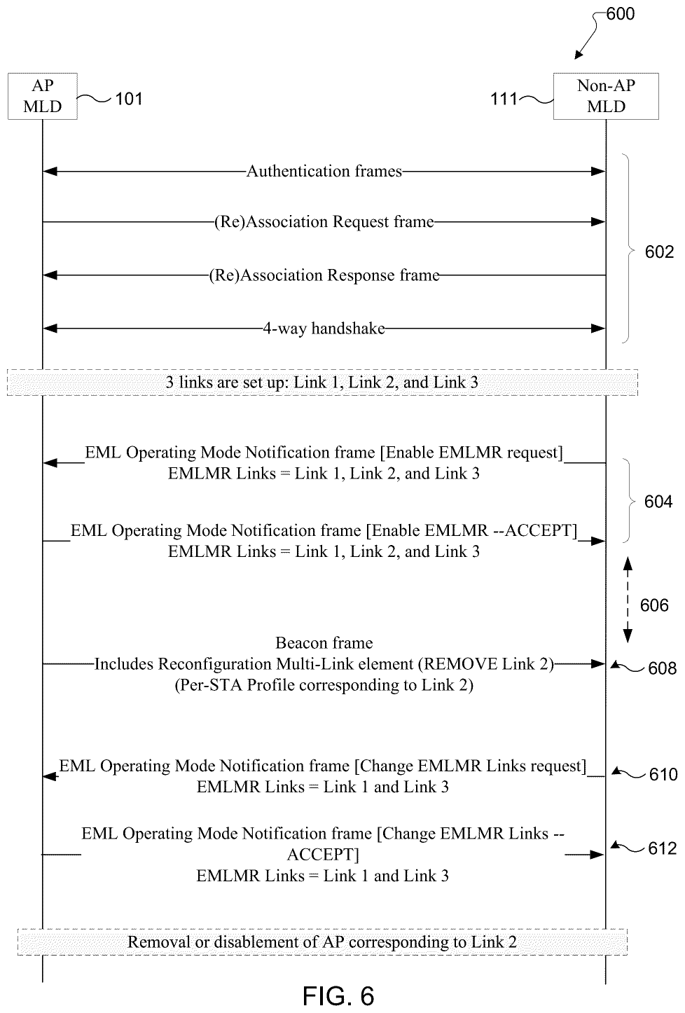

FIG. 6 illustrates an example operation 600 for EMLMR link removal before multi-link reconfiguration according to embodiments of the present disclosure. In this example, the AP MLD may be an AP MLD 101, and the non-AP MLD may be a non-AP MLD 111.

In the example of FIG. 6, the messages 602 comprise the ML setup procedure between the AP MLD and the non-AP MLD. The ML setup may be performed over any link established between an AP affiliated with the AP MLD and a STA affiliated with the non-AP MLD. In this example, after successful ML setup, three links are set up for ML operation (Link 1, Link 2, and Link 3).

The messages 604 comprise the EMLMR negotiation procedure between the AP MLD and the non-AP MLD. In this example, EMLMR is enabled on Link 1, Link 2, and Link 3 (that is, Link 1, Link 2, and Link 3 are included in the EMLMR links). EMLMR operation occurs during the time period 606 with Link 1, Link 2, and Link 3 as the EMLMR links.

The AP MLD then transmits a Beacon frame 608 that includes a Reconfiguration Multi-Link element indicating that Link 2 is to be removed (e.g., the affiliated AP corresponding to Link 2 is to be disabled or removed from affiliation with the AP MLD for ML operation). A Per-STA Profile sub-element corresponding to Link 2 is included in the Reconfiguration Multi-Link element.

In response to the Beacon frame 608, the non-AP MLD transmits a request 610 to change the EMLMR link list to Link 1 and Link 3 (i.e., to remove Link 2 from the EMLMR links). The AP MLD response with an accept message 612. Afterwards, EMLMR operation occurs with Link 1 and Link 3 as the EMLMR links, and Link 2 is removed (i.e., the affiliated AP corresponding to Link 2 is removed or disabled).

According to one embodiment, when an AP MLD recommends an associated non-AP MLD for addition of a new link, the AP MLD can provide a Complete Profile to the non-AP MLD corresponding to the link that the AP MLD is recommending for addition for the non-AP MLD. According to this embodiment, the AP MLD will set the Complete Profile subfield to 1 in the Per-STA Profile sub-element in the Reconfiguration Multi-Link element included in the Link Reconfiguration Notify frame sent by the AP MLD to the non-AP MLD in order to indicate the link addition recommendation. According to another embodiment, the STA MAC Address Present subfield and the Operation Parameters Present subfield can be set to 1. The STA MAC Address in the Per-STA Profile sub-element can be set to the MAC Address of the AP that the AP MLD intends to add for the non-AP MLD.

According to one embodiment, when an AP MLD indicates both “delete link” and “add link” operations for the same non-AP STA by setting the STA MAC Address subfield to the same value in two Per-STA Profile sub-elements included in the Reconfiguration Multi-Link element, the Link ID subfield of one of the two Per-STA Profile sub-elements can be set to the Link ID of the link that is to be deleted, and the Link ID subfield of the other Per-STA Profile sub-element can be set to the Link ID of the link that is to be added.

According to one embodiment, when an AP MLD removes an affiliated AP using the Multi-Link Reconfiguration procedure, any power saving (PS) and target wake time (TWT) information corresponding to the link that corresponds to that affiliated AP can be deleted upon removal of the link. For example, if one or more TWT schedules or agreements were established on the link and the link is removed, then upon removal of the link the TWT schedule- or TWT agreement-related information is deleted from the memory corresponding to that link.

According to another embodiment, when an AP MLD removes an affiliated AP using the Multi-Link Reconfiguration procedure, all the power saving and TWT information corresponding to the link that corresponds to that affiliated AP can be preserved after removal of the link. For example, if one or more TWT schedules or agreements were established on the link and the link is removed, then upon removal of the link the TWT schedule- or TWT agreement-related information is preserved in the memory corresponding to that link. If at a later time the AP corresponding to the removed link is re-added to the AP MLD, then the TWT schedule or agreement can be reinstated without requiring new TWT negotiation.

According to one embodiment, if a link is going to be enabled according to an advertised TID-to-Link mapping (TTLM) which indicates, in the Mapping Switch Time field of the corresponding TID-to-Link Mapping element, the time in time units (TU) of the target beacon transmission time (TBTT) of the Delivery Traffic Indication Message (DTIM) Beacon when the advertised TTLM will take effect, then a non-AP STA operating on that link can initiate a transmission opportunity (TXOP) to the corresponding AP up to a threshold amount of time before the indicated TBTT of the DTIM Beacon frame. According to one embodiment, the threshold amount can be 1 TU duration. According to another embodiment, the threshold amount can be a multiple of 1 TU time duration. According to another embodiment, the non-AP STA can initiate the TXOP to the AP if the advertised TTLM indicates that the TTLM is for uplink transmission for a TID for that link.

According to one embodiment, once an AP MLD successfully establishes an advertised TTLM, the corresponding TID-To-Link Mapping element should be included in all the Beacons and Probe Response frames transmitted by all the APs affiliated with the AP MLD until the end of the advertised TTLM as indicated by the Expected Duration field (otherwise, the newly associated client devices may initiate new TTLMs that can potentially violate the existing advertised TTLM). During this phase, the Mapping Switch Time field may not be included in the TID-To-Link Mapping element (e.g., Mapping Switch Time Present subfield can be set to 0).

According to one embodiment, immediately after the end of the lifetime of the advertised TTLM (which can be indicated by the Expected Duration field of the TID-To-Link Mapping element), the non-AP MLD should fall back to whatever negotiated TTLM agreement (if there was any) it had before the advertised TTLM was established (instead of falling back to a default mapping). If there was no negotiated TTLM agreement for that non-AP MLD, then the non-AP MLD can use a default TTLM after the end of the lifetime of the advertised TTLM.

In an example scenario, if there is a currently advertised non-default TTLM, then upon receiving an MLME-BSS-LINK-DISABLE.request primitive, each of the APs affiliated with an AP MLD will advertise a TTLM, in transmitted Beacon and Probe Response frames, that does not map any TIDs to the link on which the AP that corresponds to the BSSID parameter indicated in that primitive is operating, and that will take effect after the expiry of the time indication in the Expected Duration field of the currently advertised TTLM. According to one embodiment, at this time there will be two TTLM elements included in the Beacons and Probe Response frames transmitted by the APs affiliated with the AP MLD-one for the existing advertised TTLM (with the Mapping Switch Time not present in the TID-To-Link Mapping element) and the other for the new advertised TTLM for the disablement of the indicated link.

In an example scenario, when an AP MLD advertises that a link is disabled for all associated non-AP MLDs, a non-AP MLD remains associated with the AP MLD. According to one embodiment, this non-AP MLD can be disassociated from the AP MLD when the disablement of the link takes effect if that link is the only link that the non-AP MLD has set up with the AP MLD.

According to one embodiment, for the scenario in which a non-AP MLD intends to establish a new link with its associated AP MLD, the non-AP MLD can send a Link Reconfiguration Request frame to the AP MLD. The Link Reconfiguration Request frame can include a Basic Multi-link element to indicate the link that the non-AP MLD intends to add. The Basic Multi-Link element included in the Link Reconfiguration Request frame may also contain information pertaining to the link (or links) that is requested to be added. The Basic Multi-Link element included in the Link Reconfiguration Request frame may also contain information pertaining to links that may or may not be links that are requested to be added. According to one embodiment, a possible format of the Link Reconfiguration Request frame is shown in Table 1.

TABLE 1

| Order | Meaning |
|---|---|
| 1 | Category |
| 2 | Protected EHT Action |
| 3 | Dialog Token |
| 4 | Reconfiguration of Multi-Link element |
| 5 | OCI element |
| 6 | Basic Multi-Link element |

According to one embodiment, for the scenario in which a non-AP MLD is associated with an AP MLD and a first TWT agreement or TWT schedule is established on a first link between the AP MLD and the non-AP MLD, if the first link is deleted using the ML Reconfiguration procedure, then the information related to the first TWT agreement or TWT schedule is also deleted (i.e., the first TWT agreement or TWT schedule can be assumed to be torn down).

According to another embodiment, for the scenario in which a non-AP MLD is associated with an AP MLD and a first TWT agreement or TWT schedule is established on a first link between the AP MLD and the non-AP MLD, if the first link is deleted using the ML Reconfiguration procedure, then the information related to the first TWT agreement or TWT schedule is NOT deleted (i.e., the first TWT agreement or TWT schedule can be assumed to be suspended).

According to one embodiment, for the scenario in which a non-AP MLD is associated with an AP MLD and a first TWT agreement or TWT schedule is established on a first link between the AP MLD and the non-AP MLD, if the first link is disabled using the TID-To-Link Mapping procedure, then the information related to the first TWT agreement or TWT schedule is deleted (i.e., the first TWT agreement or TWT schedule can be assumed to be torn down).

According to one embodiment, for the scenario in which a non-AP MLD is associated with an AP MLD and a first TWT agreement or TWT schedule is established on a first link between the AP MLD and the non-AP MLD, if the first link is disabled using the TID-To-Link Mapping procedure, then the information related to the first TWT agreement or TWT schedule is NOT deleted (i.e., the first TWT agreement or TWT schedule can be assumed to be suspended. When the link is enabled again, the TWT agreement or TWT schedule is re-instantiated or resumed).

According to one embodiment, for the scenario in which a non-AP MLD receives a link reconfiguration recommendation from its associated AP MLD by receiving a Link Reconfiguration Notify frame from the AP MLD, if the non-AP MLD subsequently transmits a Link Recommendation Request frame to the AP MLD as a response to receiving the Link Reconfiguration Notify frame, then the non-AP MLD, in the Link Recommendation Request frame transmitted to the AP MLD, can set the Dialog Token field to the same value as indicated in the Dialog Token field of the Link Recommendation Notify frame received from the AP MLD. This would indicate that the Request frame is of the same notify/request/response sequence as the Link Recommendation Notify frame.

According to one embodiment, for the scenario in which a non-AP MLD is associated with an AP MLD and a single link (e.g., a first link) is established between the AP MLD and the non-AP MLD, if the AP MLD announces that the first link is to be deleted (using the ML Reconfiguration procedure), then the non-AP MLD can send a Link Reconfiguration Request frame to the AP MLD in order to indicate a request to establish a second link between the AP MLD and the non-AP MLD. The non-AP MLD may send this request to the AP MLD (by sending the Link Reconfiguration Request frame to the AP MLD to establish the second link between the AP MLD and the non-AP MLD) before the first link is scheduled to be deleted. In this way the non-AP MLD can avoid being disassociated from the AP MLD.

According to one embodiment, for the scenario in which a first link is established between a first AP affiliated with an AP MLD and a first non-AP STA affiliated with a non-AP MLD that is associated with the AP MLD, the non-AP MLD can send a request to the AP MLD to delete the first link between the first AP and the first non-AP STA, and can request that the AP MLD establish a second link between the first non-AP STA and a second AP affiliated with the same AP MLD.

According to one such embodiment, to request that the AP MLD delete the first link between the first AP and the first non-AP STA and also request that the AP MLD establish a second link between the first non-AP STA and a second AP affiliated with the same AP MLD, the non-AP MLD can send a Link Reconfiguration Request frame to the AP MLD through any enabled link between the AP MLD and the non-AP MLD.

The Link Reconfiguration Request frame may contain a Multi-Link Reconfiguration element that can contain two Per-STA Profile sub-elements. The first Per-STA Profile sub-element may indicate that it is for deleting an existing link (the first link) by setting the Reconfiguration Operation Type subfield value to 3 (Delete Link). The Link ID subfield of the first Per-STA Profile sub-element can be set to the link ID value corresponding to the first AP, and the STA MAC Address of the first Per-STA Profile sub-element can be set to the STA MAC address value of the first non-AP STA. The second Per-STA Profile sub-element may indicate that it is for adding a new link (the second link) by setting the Reconfiguration Operation Type subfield value to 2 (Add Link). The Link ID subfield of the second Per-STA Profile sub-element can be set to the link ID value corresponding to the second AP affiliated with the AP MLD, and the STA MAC Address of the second Per-STA Profile sub-element can be set to the STA MAC address value of the first non-AP STA.

The non-AP MLD can send the Link Reconfiguration Request frame to the AP MLD over the same link as the link that is being requested to be deleted or can send the Link Reconfiguration Request frame over a different link than the link that is being requested to be deleted.

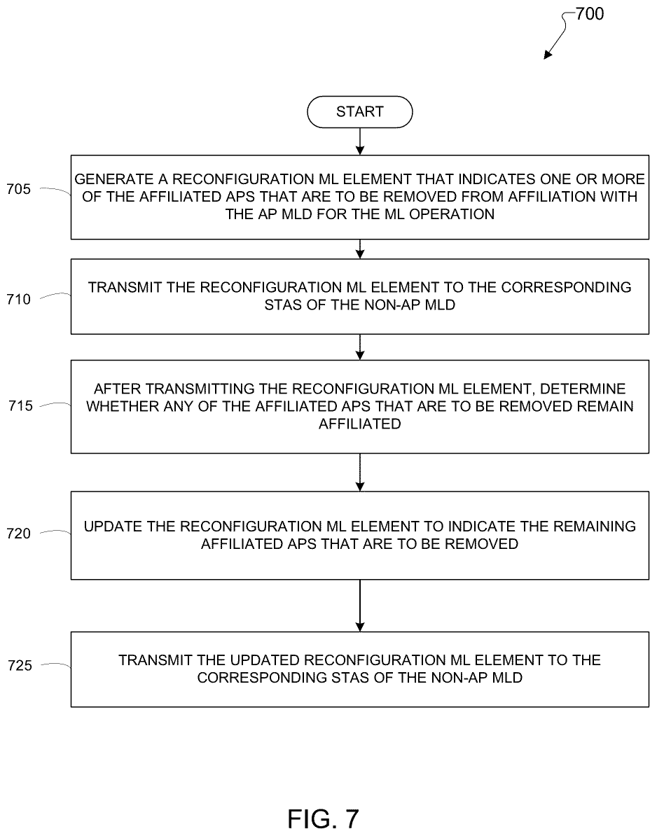

FIG. 7 illustrates an example process 700 for reconfiguration of setup links between MLDs according to various embodiments of the present disclosure. The process 700 of FIG. 7 is discussed as being performed by an AP MLD, but it is understood that a corresponding non-AP MLD performs a corresponding process. Additionally, for convenience the process of FIG. 7 is discussed as being performed by a WI-FI AP MLD comprising a plurality of APs that each comprise a transceiver configured to configured to transmit on a link setup with a corresponding STA of a WI-FI non-AP MLD, wherein the APs are affiliated with the AP MLD for ML operation on the setup links. However, it is understood that any suitable wireless communication device could perform this process.

Referring to FIG. 7, at step 705 a processor of the AP MLD may generate a reconfiguration ML element that indicates one or more of the affiliated APs that are to be removed from affiliation with the AP MLD for the ML operation. In some embodiments, the reconfiguration ML element includes a per-STA profile sub-element corresponding to each of the affiliated APs that are to be removed.

In some embodiments, the processor sets a MAC address present subfield in the reconfiguration ML element to 0, and the AP MLD is identified by an MLD MAC Address subfield of a basic ML element corresponding to the AP MLD. In other embodiments, the processor sets the MAC address present subfield in the reconfiguration ML element to 1, and includes an MLD MAC address of the AP MLD in the reconfiguration ML element. This may be done based on a determination that one affiliated AP is to be removed.

Next, the transceivers may transmit the reconfiguration ML element to the corresponding STAs of the non-AP MLD (step 710).

After transmitting the reconfiguration ML element, the processor may determine whether any of the affiliated APs that are to be removed remain affiliated (step 715).

The processor may then update the reconfiguration ML element to indicate the remaining affiliated APs that are to be removed (step 720). If the reconfiguration ML element of step 705 includes a per-STA profile sub-element corresponding to each of the affiliated APs that are to be removed, then the processor at step 720 may update the reconfiguration ML element by removing the per-STA profile sub-element corresponding to each AP removed from affiliation.

Finally, the transceivers of remaining affiliated APs may transmit the updated reconfiguration ML element to the corresponding STAs of the non-AP MLD (step 725). In some embodiments, this step may be performed based on at least one per-STA profile sub-element remaining in the updated reconfiguration ML element.

When there are no setup links remaining after the APs being removed from affiliation, the non-AP MLD is considered disassociated from the AP MLD.

In some embodiments, the transceivers of the AP MLD operate in EMLSR or EMLMR mode on at least one of the setup links corresponding to an affiliated AP that is to be removed. In such embodiments, after transmitting the reconfiguration ML element at step 710 or step 725, the transceivers may receive, from the corresponding STAs of the non-AP MLD, a request to remove the at least one setup link from the EMLSR or EMLMR operation before the corresponding affiliated AP is removed.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An access point (AP) multi-link device (MLD) comprising:
APs each comprising a transceiver configured to transmit on a link setup with a corresponding station (STA) of a non-AP MLD, wherein the APs are affiliated with the AP MLD for multi-link (ML) operation on the setup links; and
a processor operably coupled to the APs, the processor configured to generate a reconfiguration ML element that indicates one or more of the affiliated APs that are to be removed from affiliation with the AP MLD for the ML operation,
wherein the transceivers are further configured to transmit the reconfiguration ML element to the corresponding STAs of the non-AP MLD,
wherein the processor is further configured to:
after transmitting the reconfiguration ML element, determine whether any of the affiliated APs that are to be removed remain affiliated, and
update the reconfiguration ML element to indicate the remaining affiliated APs that are to be removed, and
wherein the transceivers of remaining affiliated APs are further configured to transmit the updated reconfiguration ML element to the corresponding STAs of the non-AP MLD.

2. The AP MLD of claim 1, wherein:
the reconfiguration ML element includes a per-STA profile sub-element corresponding to each of the affiliated APs that are to be removed, and
the processor is configured to update the reconfiguration ML element by removing the per-STA profile sub-element corresponding to each AP removed from affiliation.

3. The AP MLD of claim 2, wherein the transceivers of the remaining affiliated APs are further configured to transmit the updated reconfiguration ML element based on at least one per-STA profile sub-element remaining in the updated reconfiguration ML element.

4. The AP MLD of claim 1, wherein:
the processor is further configured to set a medium access control (MAC) address present subfield in the reconfiguration ML element to 0, and
the AP MLD is identified by an MLD MAC Address subfield of a basic ML element corresponding to the AP MLD.

5. The AP MLD of claim 1, wherein the processor is further configured to:
set a MAC address present subfield in the reconfiguration ML element to 1, based on a determination that one AP that is to be removed remains affiliated, and
include an MLD MAC address of the AP MLD in the reconfiguration ML element.

6. The AP MLD of claim 1, wherein, based on no setup links remaining after the APs being removed from affiliation, the non-AP MLD is considered disassociated from the AP MLD.

7. The AP MLD of claim 1, wherein the transceivers are further configured to:
operate in an enhanced ML single-radio (EMLSR) or enhanced ML multi-radio (EMLMR) mode on at least one of the setup links corresponding to an affiliated AP that is to be removed, and
receive, from the corresponding STAs of the non-AP MLD, a request to remove the at least one setup link from the EMLSR or EMLMR operation before the corresponding affiliated AP is removed.

8. A method of wireless communication performed by an access point (AP) multi-link device (MLD) that comprises APs each comprising a transceiver configured to transmit on a link setup with a corresponding station (STA) of a non-AP MLD, wherein the APs are affiliated with the AP MLD for multi-link (ML) operation on the setup links, the method comprising:
generating, by a processor of the AP MLD, a reconfiguration ML element that indicates one or more of the affiliated APs that are to be removed from affiliation with the AP MLD for the ML operation;
transmitting, by the transceivers, the reconfiguration ML element to the corresponding STAs of the non-AP MLD;
after transmitting the reconfiguration ML element, determining, by the processor, whether any of the affiliated APs that are to be removed remain affiliated;
updating, by the processor, the reconfiguration ML element to indicate the remaining affiliated APs that are to be removed; and
transmitting, by the transceivers of remaining affiliated APs, the updated reconfiguration ML element to the corresponding STAs of the non-AP MLD.

9. The method of claim 8, wherein:
the reconfiguration ML element includes a per-STA profile sub-element corresponding to each of the affiliated APs that are to be removed, and
the method further comprises updating, by the processor, the reconfiguration ML element by removing the per-STA profile sub-element corresponding to each AP removed from affiliation.

10. The method of claim 9, further comprising transmitting, by the transceivers of the remaining affiliated APs, the updated reconfiguration ML element based on at least one per-STA profile sub-element remaining in the updated reconfiguration ML element.

11. The method of claim 8, further comprising:
setting, by the processor, a medium access control (MAC) address present subfield in the reconfiguration ML element to 0,
wherein the AP MLD is identified by an MLD MAC Address subfield of a basic ML element corresponding to the AP MLD.

12. The method of claim 8, further comprising:
setting, by the processor, a MAC address present subfield in the reconfiguration ML element to 1, based on a determination that one AP that is to be removed remains affiliated, and
including, by the processor, an MLD MAC address of the AP MLD in the reconfiguration ML element.

13. The method of claim 8, wherein, based on no setup links remaining after the APs being removed from affiliation, the non-AP MLD is considered disassociated from the AP MLD.

14. The method of claim 8, wherein:
the transceivers operate in an enhanced ML single-radio (EMLSR) or enhanced ML multi-radio (EMLMR) mode on at least one of the setup links corresponding to an affiliated AP that is to be removed, and
the method further comprises receiving, by the transceivers from the corresponding STAs of the non-AP MLD, a request to remove the at least one setup link from the EMLSR or EMLMR operation before the corresponding affiliated AP is removed.

15. A non-access point (AP) multi-link device (MLD) comprising:
stations (STAs) each comprising a transceiver configured to:
transmit on a link setup with a corresponding AP of an AP MLD, wherein the APs are affiliated with the AP MLD for multi-link (ML) operation on the setup links, and
receive a reconfiguration ML element from the corresponding AP of the AP MLD; and
a processor operably coupled to the STAs, the processor configured to determine that the reconfiguration ML element indicates one or more of the affiliated APs that are to be removed from affiliation with the AP MLD for the ML operation,
wherein, the transceivers are further configured to, after receiving the reconfiguration ML element, receive an updated reconfiguration ML element from corresponding remaining affiliated APs of the AP MLD, and
wherein the processor is further configured to determine that the updated reconfiguration ML element indicates remaining affiliated APs that are to be removed.

16. The non-AP MLD of claim 15, wherein:
the reconfiguration ML element includes a per-STA profile sub-element corresponding to each of the affiliated APs that are to be removed, and
the per-STA profile sub-element corresponding to each AP removed from affiliation is removed from the updated reconfiguration ML element.

17. The non-AP MLD of claim 16, wherein at least one per-STA profile sub-element remains in the updated reconfiguration ML element.

18. The non-AP MLD of claim 15, wherein the processor is further configured to determine, based on a medium access control (MAC) address present subfield in the reconfiguration ML element being set to 0, that the AP MLD is identified by an MLD MAC Address subfield of a basic ML element corresponding to the AP MLD.

19. The non-AP MLD of claim 15, wherein:
the processor is further configured to determine, based on a MAC address present subfield in the reconfiguration ML element being set to 1, that an MLD MAC Address of the AP MLD is included in the reconfiguration ML element, and
the MAC address present subfield is set to 1 based on one AP that is to be removed remaining affiliated.

20. The non-AP MLD of claim 15, wherein, based on no setup links remaining after the APs being removed from affiliation, the non-AP MLD is considered disassociated from the AP MLD.
